(19) United States
(12) Patent Application Publication
(10) Pub. No.: US 2022/0320700 A1
(43) Pub. Date: Oct. 6, 2022

(54) WAVEGUIDE FOR RADAR

(71) Applicant: HYUNDAI MOBIS CO., LTD., Seoul (KR)

(72) Inventor: Sang Hee BAE, Yongin-si (KR)

(73) Assignee: HYUNDAI MOBIS CO., LTD., Seoul (KR)

(21) Appl. No.: 17/339,871

(22) Filed: Jun. 4, 2021

(30) Foreign Application Priority Data
Apr. 1, 2021 (KR) 10-2021-0042961

(51) Int. Cl. H01P 3/12; H01Q 1/50

(52) U.S. Cl. CPC H01P 3/12; H01Q 1/50

(57) ABSTRACT

A waveguide for a radar, in which a passage is formed by walls having a predetermined thickness to guide electromagnetic waves that a radar element transmits and receives, and all parts including the walls are made of conductive plastic having frequency surface resistance of 1000Ω or less and magnetic permeability of 0.001 H/m or more.

### CROSS REFERENCE TO RELATED APPLICATION

The present application claims priority to Korean Patent Application No. 10-2021-0042961, filed Apr. 1, 2021, the entire contents of which is incorporated herein for all purposes by this reference.

### BACKGROUND OF THE INVENTION

### Field of the Invention

The present invention relates to a waveguide that is used for small-sized radars that can be mounted on vehicles, etc.

### Description of the Related Art

Recently, vehicles sense obstacles on roads so that users can more conveniently and safely drive, and vehicles equipped with radars (Radio Detecting And Ranging) for sensing obstacles to achieve self-driving have increased.

In order to be mounted on vehicles, etc., radars should be as small and light as possible and should have a sufficient obstacle sensing ability.

The description provided above as a related art of the present invention is just for helping understanding the background of the present invention and should not be construed as being included in the related art known by those skilled in the art.

### SUMMARY OF THE INVENTION

An objective of the present invention is to provide a waveguide for a radar which is applied to a micro-radar that can be mounted on a vehicle, etc., can effectively guide electromagnetic waves, which are radiated from a radar element and reflected by a sensing target, while minimizing a loss of energy of the electromagnetic waves, can sufficiently secure sensing performance of a radar, can be simply manufactured and assembled, and can be reduced in manufacturing cost and weight.

In order to achieve the objectives described above, the present invention provides a waveguide for a radar, in which a passage is formed by walls having a predetermined thickness to guide electromagnetic waves that a radar element transmits and receives, and all parts including the walls are made of conductive plastic having frequency surface resistance of 1000Ω or less and magnetic permeability of 0.001H/m or more.

The thickness of the walls may be 3 mm or less.

The conductive plastic may be PA66 (Polyamide 66) that contains 35˜40% carbon fiber and 2% carbon nanotubes.

The conductive plastic may be PBT (Polybutylene terephthalate) that contains 35˜40% carbon fiber and 2% carbon nanotubes.

The walls may include an enlarging part formed such that a cross-sectional area of the passage increases away from the radar element.

Several coupling protrusions that fix the waveguide to a circuit board by being thermally bonded through the circuit board may be integrally formed at ends, which face the circuit board having the radar element mounted thereon, of both ends of the walls forming the passage.

The walls may be symmetrically disposed in four directions around the passage and the enlarging part formed by the walls forms a cuboidal passage gradually increasing in cross-sectional area away from the radar element.

A partition dividing the passage into two parts by connecting two walls facing each other may be integrally formed in the passage.

The walls may form a constant part forming a cuboidal passage having a uniform cross-sectional area regardless of a distance from the radar element, at a position closer to the radar element than the enlarging part.

The several protrusions may protrude from edges of the constant part, respectively.

According to the present invention, a waveguide for a radar is applied to a micro-radar that can be mounted on a vehicle, etc., can effectively guide electromagnetic waves, which are radiated from a radar element and reflected by a sensing target, while minimizing a loss of energy of the electromagnetic waves, can sufficiently secure sensing performance of a radar, can be simply manufactured and assembled, and can be reduced in manufacturing cost and weight.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 is an exploded perspective view of a radar to which a waveguide according to the present invention can be applied;

FIG. 2 is a view showing a waveguide for a radar according to the present invention;

FIG. 3 is a side view of the waveguide shown in FIG. 2;

FIG. 4 is a table showing wall thicknesses, which can satisfy a radar characteristic, according to changes in frequency surface resistance and a magnetic permeability of a conductive plastic;

FIG. 5 is a table comparing horizontal and vertical beam pattern performance of a radar using a waveguide made of a conductive plastic with those of a radar using a waveguide made of another material in the related art;

FIG. 6 is a view comparing horizontal beam pattern performance of a radar equipped with a waveguide made of a conductive plastic according to a content with that of a radar equipped with a waveguide made of another material;

FIG. 7 is a view comparing vertical beam pattern performance of a radar equipped with a waveguide made of a conductive plastic according to a content with that of a radar equipped with a waveguide made of another material;

FIG. 8 is a view showing that coupling protrusions of a waveguide are thermally bonded through a circuit board;

FIG. 9 is a view showing the gap A between a waveguide and a circuit board; and

FIG. 10 is a view comparing horizontal beam patterns according to the gap A between a waveguide and a circuit board.

### DETAILED DESCRIPTION OF THE INVENTION

In the following description, the structural or functional description specified to exemplary embodiments according to the concept of the present invention is intended to describe the exemplary embodiments, so it should be understood that the present invention may be variously embodied, without being limited to the exemplary embodiments.

Embodiments described herein may be changed in various ways and various shapes, so specific embodiments are shown in the drawings and will be described in detail in this specification. However, it should be understood that the exemplary embodiments according to the concept of the present invention are not limited to the embodiments which will be described hereinbelow with reference to the accompanying drawings, but all of modifications, equivalents, and substitutions are included in the scope and spirit of the present invention.

It will be understood that, although the terms first and/or second, etc. may be used herein to describe various elements, these elements should not be limited by these terms. These terms are only used to distinguish one element, from another element. For instance, a first element discussed below could be termed a second element without departing from the right range of the present invention. Similarly, the second element could also be termed the first element.

It is to be understood that when one element is referred to as being “connected to” or “coupled to” another element, it may be connected directly to or coupled directly to another element or be connected to or coupled to another element, having the other element intervening therebetween. On the other hand, it should to be understood that when one element is referred to as being “connected directly to” or “coupled directly to” another element, it may be connected to or coupled to another element without the other element intervening therebetween. Further, the terms used herein to describe a relationship between elements, that is, “between”, “directly between”, “adjacent” or “directly adjacent” should be interpreted in the same manner as those described above.

The terminology used herein is for the purpose of describing particular embodiments only and is not intended to limit the present invention Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless otherwise defined, all terms including technical and scientific terms used herein have the same meaning as commonly understood by those skilled in the art to which the present invention belongs. It must be understood that the terms defined by the dictionary are identical with the meanings within the context of the related art, and they should not be ideally or excessively formally defined unless the context clearly dictates otherwise.

The present invention will be described hereafter in detail by describing exemplary embodiments of the present invention with reference to the accompanying drawings. Like reference numerals given in the drawings indicate like components.

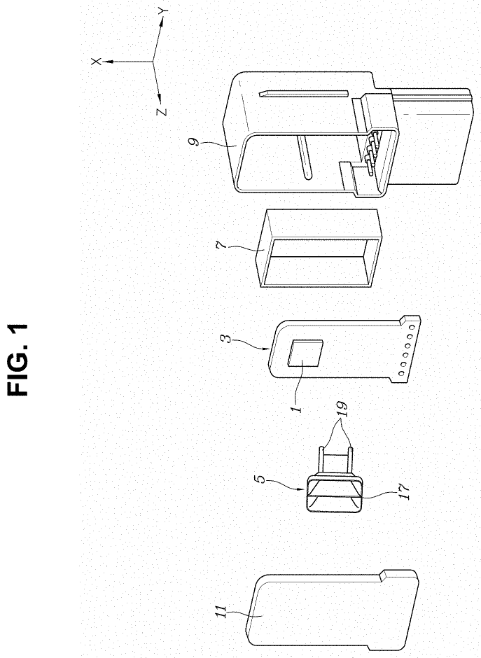

Referring to FIG. 1, a radar to which a waveguide 5 of the present invention includes a radar element 1 that is a semiconductor element transmitting and receiving electromagnetic waves, a circuit board 3 having the radar element 1 and a circuit for driving the radar element 1 thereon, a waveguide 5 installed to guide electromagnetic waves that are transmitted from and received to the radar element 1, a shield can 7 covering the rear of the circuit board 3 having the radar element 1 thereon, a housing 9 covering the circuit board 3, the waveguide 5, and the shield can 7, and a radom 11 installed to seal the housing 9 in front of the waveguide 5.

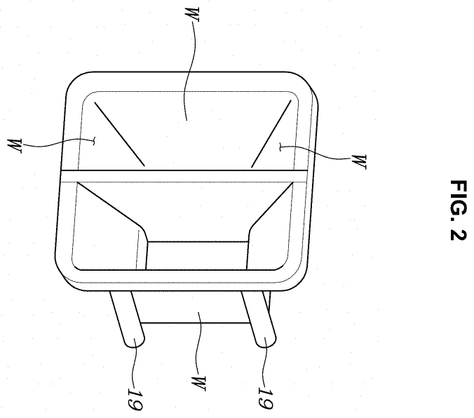

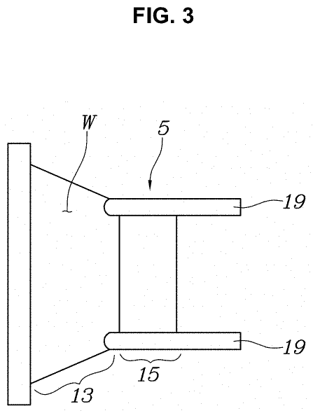

Referring to FIGS. 2 and 3, an embodiment of the waveguide 5 for a radar of the present invention forms a passage including walls W having a predetermined thickness to guide electromagnetic waves that are transmitted and received by the radar element 1.

The walls W have an enlarging part 13 where the passage increases in cross-sectional area away from the radar element 1.

In this embodiment, the walls W are symmetrically disposed in four directions around the passage. The enlarging part 13 formed by the walls W forms a cuboidal passage gradually increasing in cross-sectional area away from the radar element 1.

The walls W form a constant part 15 forming a cuboidal passage having a uniform cross-sectional area regardless of the distance from the radar element 1, at a position closer to the radar element 1 than the enlarging part 13.

That is, according to the waveguide 5 of the present invention, four walls W forming the passage for electromagnetic waves are connected to each other, whereby the constant part 15 is formed close to the radar element 1 and the enlarging part 13 is integrally connected to the constant part 15 and has a shape having an internal passage of which the cross-section gradually increases away from the radar element 1.

In this embodiment, the walls W, in the parts of the waveguide 5, mean the parts that are flat and of which the thicknesses measured perpendicular to the surfaces can maintain a substantially constant level to be discriminated from parts that are difficult to be expressed with a constant thickness such as the edges where the walls W are connected to each other.

Accordingly, the waveguide 5 may substantially have several walls that can form a hexagonal passage or an octagonal passage rather than the rectangular passage formed by four walls W, as described above, and may be formed in a cylindrical shape.

Meanwhile, according to the waveguide 5 of the present invention, as shown in the figures, a partition 17 dividing the passage into two sections is integrally formed in the passage by connecting two walls W facing each other.

Accordingly, it is possible to secure more excellent radar performance by matching a transmission region and a reception region of the radar element 1 to the two passages separated by the partition 17, respectively.

Further, the partition 17 contributes to increasing strength of the waveguide 5 and suppressing deformation of the waveguide 5.

All parts including the walls W of the waveguide 5 are made of a conductive plastic having a frequency surface resistance of 1000Ω or less and a magnetic permeability of 0.001H/m or more.

That is, the waveguide 5 may be a single injection mold of which all parts are formed at one time by injection molding and the thicknesses of the walls W may be 3 mm or less to improve formability and reduce the size and weight of a radar. In this case, the conductive plastic that is used in injection molding of the waveguide 5, as described above, may have a frequency surface resistance of 1000Ω or less and a magnetic permeability of 0.001 H/m or more.

That is, the thicknesses of the walls W made of the conductive plastic of the waveguide 5 can be obtained from the following Skin Depth formula.

$$\text{?} = \frac{1}{\sqrt{{πμ}_{o}}} \sqrt{\frac{ρ}{\text{?}}} \approx 503 \sqrt{\frac{ρ}{\text{?}}} \qquad [ Formula 1 ]$$

$$\text{?} \text{indicates text missing or illegible when filed}$$

δ: thickness of wall W

μₒ: vacuum magnetic permeability: 4^{π}*10-7 (H/m)

μᵣ: relative permeability=μ/μₒ

μ: magnetic permeability of material of wall W

ρ: specific resistance (Ω·m) of material of wall W for Cu (1.68*10-8 Ω·m)

f: operating frequency of radar

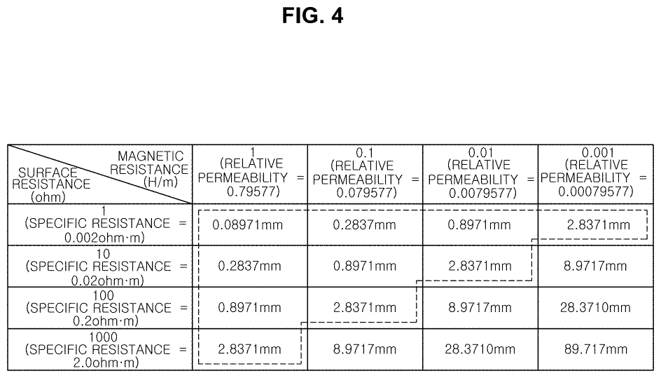

Thicknesses of the walls W were calculated through the formula while changing the frequency surface resistance and the magnetic permeability of a conductive plastic that can be used for the waveguide 5, and in this case, the result shown in FIG. 4 could be obtained.

That is, the combinations of the frequency surface resistance and the magnetic permeability of the conductive plastic that can achieve a thickness of 3 mm or less of the walls W, which are indicated by a dotted line in FIG. 4, are limited to the case when the frequency surface resistance is 1000Ω or less and the magnetic permeability is 0.001H/m or more.

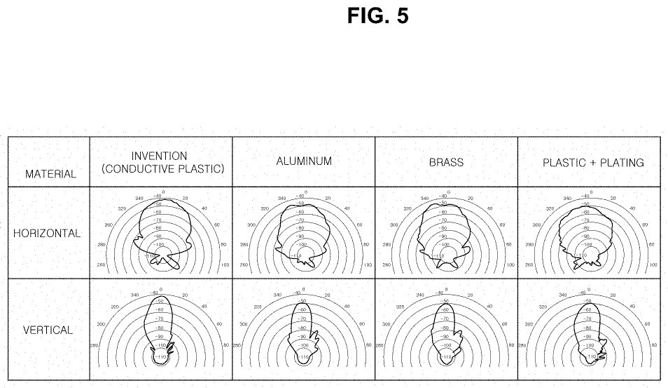

FIG. 5 is a table comparing horizontal and vertical beam pattern performance of a radar using a waveguide 5 made of a conductive plastic described above with those of a radar using a waveguide made of another material in the related art. It can be seen that a radar using the waveguide 5 according to the present invention provides performance at substantially the same level as a radar using a waveguide made of another material in the related art.

That is, the waveguide 5 made of a conductive plastic of the present invention has the advantage that the same performance can be secured, manufacturing and assembling are easy, the weight is low, and the manufacturing cost can be remarkably reduced because it is a single injection-molded product, in comparison to waveguides made of metallic materials such as aluminum or brass or plastic and then plated in the related art.

The conductive plastic may be PA66 (Polyamide 66) containing 35˜40% CF (Carbon Fiber) and 2% CNT (Carbon Nano Tube) or PBT (Polybutylene terephthalate) containing 35˜40% CF and 2% CNT.

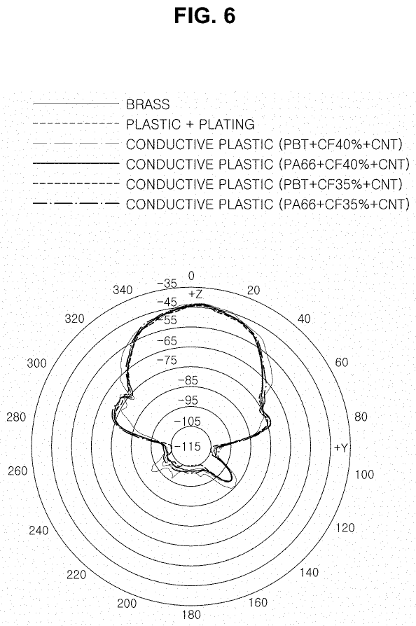

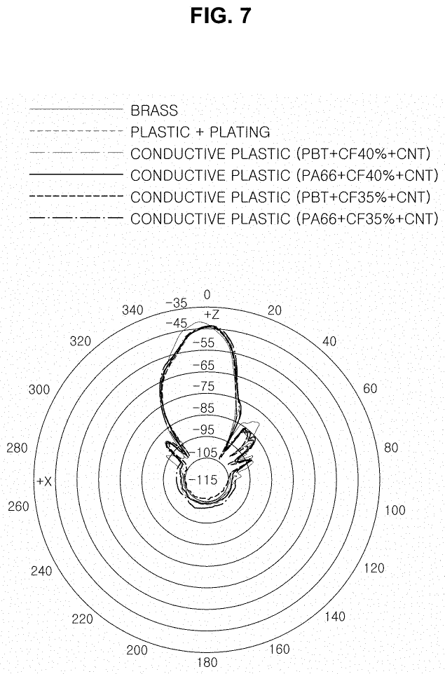

For reference, FIGS. 6 and 7 are views comparing horizontal and vertical beam pattern performance of a radar equipped with a waveguide 5 made of conductive plastic having the contents described above. It can be seen from the figures that the same performance can be provided when the conductive plastic having the contents described above, as compared with when a waveguide made of brass or plastic and then plated is used in the related art.

For reference, in FIGS. 5 to 7, the horizontal beam pattern performance is beam pattern performance in a plane (YZ plane) perpendicular to the walls 17 in the waveguide 5 shown in FIG. 1 and vertical beam pattern performance is beam pattern performance in a plane (YZ plane) perpendicular to the walls 17.

Meanwhile, several coupling protrusions 19 that fix the waveguide 5 to the circuit board 3 by being thermally bonded through the circuit board 3 are integrally formed at the ends, which face the circuit board 3 having the radar element 1 mounted thereon, of both ends of the walls W forming the passage of the waveguide 5.

That is, in this embodiment, the coupling protrusions 19, as shown in FIGS. 2 and 3, integrally protrude from the edges of the constant part 15, respectively.

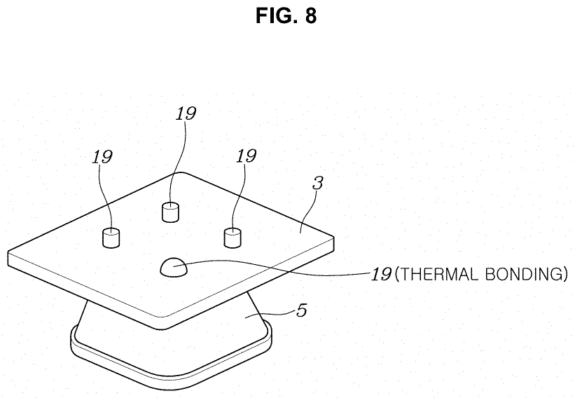

Since the coupling protrusions 19 are made of conductive plastic as a part of the waveguide 5, as shown in FIG. 8, they are disposed through the circuit board 3 and then deformed on the rear of the circuit board 3 by thermal bonding, thereby being able to firmly fix the waveguide 5 to the circuit board 3.

In particular, the coupling protrusions 19 can easily fix the waveguide 5 such that the waveguide 5 is in close contact with the circuit board 3 and can permanently maintain the fixed state, whereby maximum performance of the radar can be secured and the state can be stably maintained.

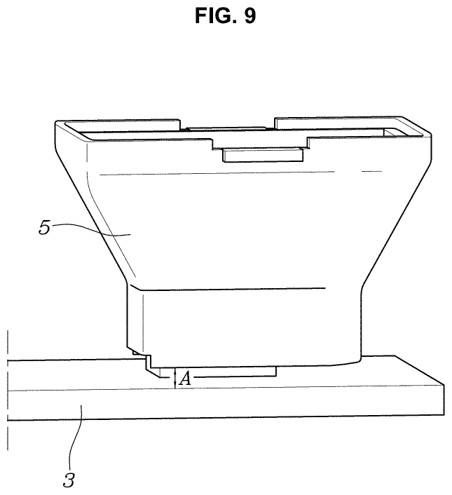

Referring to FIG. 9, it is shown that the waveguide 5 can be assembled with a small gap A from the circuit board 3. This state can occur when the waveguide 5 is fixed to the circuit board 3 using an adhesive, etc., but the larger the gap A, the lower the performance of the radar.

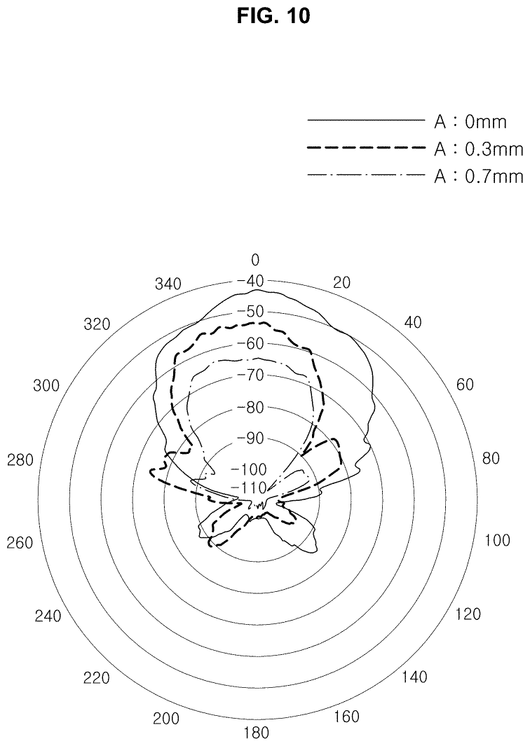

FIG. 10 compares horizontal beam pattern performance of a radar according to the gap A, in which it can be seen that the beam pattern is the most excellent when the gap is 0, and the larger the gap, the lower the beam pattern performance.

That is, in the present invention, as described above, since the several coupling protrusions 19 are inserted through the circuit board 3 and then thermally bonded to the circuit board 3, the firmly fixed state in close contact can be easily secured without a gap between the waveguide 5 and the circuit board 3, which is very advantageous in terms of securing the performance of a radar.

Although the present invention was described with reference to specific embodiments shown in the drawings, it is apparent to those skilled in the art that the present invention may be changed and modified in various ways without departing from the scope of the present invention which is described in the following claims.

What is claimed is:

1. A waveguide for a radar, comprising:
a passage formed by walls having a predetermined thickness to guide electromagnetic waves that a radar element transmits and receives, and
wherein all parts including the walls are made of conductive plastic having frequency surface resistance of 1000Ω or less and magnetic permeability of 0.001 H/m or more.

2. The waveguide of claim 1, wherein the predetermined thickness of the walls is 3 mm or less.

3. The waveguide of claim 1, wherein the conductive plastic is PA66 (Polyamide 66) that contains 35˜40% carbon fiber and 2% carbon nanotubes.

4. The waveguide of claim 1, wherein the conductive plastic is PBT (Polybutylene terephthalate) that contains 35˜40% carbon fiber and 2% carbon nanotubes.

5. The waveguide of claim 1, wherein the walls include an enlarging part formed such that a cross-sectional area of the passage increases away from the radar element.

6. The waveguide of claim 5, wherein several coupling protrusions that fix the waveguide to a circuit board by being thermally bonded through the circuit board are integrally formed at ends, which face the circuit board having the radar element mounted thereon, of both ends of the walls forming the passage.

7. The waveguide of claim 6, wherein the walls are symmetrically disposed in four directions around the passage and the enlarging part formed by the walls forms a cuboidal passage gradually increasing in cross-sectional area away from the radar element.

8. The waveguide of claim 7, wherein a partition dividing the passage into two parts by connecting two walls facing each other is integrally formed in the passage.

9. The waveguide of claim 7, wherein the walls form a constant part forming a cuboidal passage having a uniform cross-sectional area regardless of a distance from the radar element, at a position closer to the radar element than the enlarging part.

10. The waveguide of claim 9, wherein the several coupling protrusions protrude from edges of the constant part, respectively.

11. A radar comprising the waveguide of claim 1.

12. A radar comprising the waveguide of claim 2.

13. A radar comprising the waveguide of claim 3.

14. A radar comprising the waveguide of claim 4.

15. A radar comprising the waveguide of claim 5.

16. A radar comprising the waveguide of claim 6.

17. A radar comprising the waveguide of claim 7.

18. A radar comprising the waveguide of claim 8.

19. A radar comprising the waveguide of claim 9.

20. A radar comprising the waveguide of claim 10.
